(19) United States
(12) Patent Application Publication
(10) Pub. No.: US 2024/0044454 A1
(43) Pub. Date: Feb. 8, 2024

(54) COLLAPSIBLE CONTAINER FOR CRYOGENIC STORAGE AND MOVEMENT

(71) Applicant: WASHINGTON STATE UNIVERSITY, Pullman, WA (US)

(72) Inventors: Kjell G. WESTRA, Pullman, WA (US); Jacob W. LEACHMAN, Pullman, WA (US); Patrick Marshall ADAM, Pullman, WA (US); Francis DUNNE, Pullman, WA (US)

(21) Appl. No.: 18/264,500

(22) PCT Filed: Feb. 8, 2022
(86) PCT No.: PCT/US2022/015563

§ 371 Date: Aug. 7, 2023

Related U.S. Application Data
(60) Provisional application No. 63/146,794, filed on Feb. 8, 2021.

(51) Int. Cl. F17C 3/10; F17C 9/00; B29C 51/36; B29C 33/42

(52) U.S. Cl. CPC F17C 3/10; F17C 9/00; B29C 51/36; B29C 33/42; F17C 2223/0161; F17C 2201/0195; F17C 2203/0379; F17C 2203/0673; F17C 2227/0135; F17C 2270/0194; F17C 2209/2109; F17C 2270/0197; F17C 2221/012; F17C 2221/011; F17C 2203/0329; F17C 2203/0629; F17C 2203/0639; F17C 2203/0646; F17C 2203/0682; F17C 2227/0355; F17C 2227/0381; B29C 51/10

(57) ABSTRACT

Collapsible containers are an attractive alternative to surface-tension propellant management devices (PMDs) for handling cryogenic liquids, as the collapsible container comparatively may 1) allow higher expulsion flow rates than vanes and sponges, 2) significantly reduce operational complexity, and 3) thermally insulate the propellant from environmental heat leaks. Furthermore, while historical cryogenic collapsible containers suffered from the low ductility of polymer films at cryogenic temperatures, the technology disclosed herein shows that the incorporation of folded patterns into the collapsible container substantially increases the reusability of the cryogenic PMD.

### FIELD OF THE INVENTION

This invention generally relates to a collapsible container used to provide fluid flow in low, micro, or non-gravitational environments. The container accomplishes the flow of fluid in any gravitational environment using specific structural components of the container.

### BACKGROUND OF THE INVENTION

Storage of space flight fuels presents a specific problem in microgravity environments. The problem of evacuating a fuel storage tank currently relies on a propellant management device (“PMD”). The PMD enables a process by which fuel is expelled from a reservoir in a low-gravity or microgravity environment. PMDs can rely on a number of mechanisms to function however surface tension is used as a primary expulsion device, in combination with baffles, fins, and vanes. The resultant goal of a PMD is to provide liquid fuel to rocket engines without adding gas to the liquid fuel. PMD cannot utilize the forces of gravity or buoyancy to determine or utilize fuel levels within a storage container. Furthermore, the position of fuel is normally determined by surface tension, where the liquids coalesce to form a gaseous bubble located in the center of the container. PMD must deliver gas free liquid fuel to the engine in order to operate.

A PMD can be grouped in two types, a total communication PMD or a control type PMD. A total communication PMD acquires propellant from anywhere it is located within the container. Total communication PMDs can utilize vanes, gallerys, or pleated liners to enhance transport of liquid. Vanes are used for situations where there are low propellant needs, for instance in low acceleration periods. The mechanical features allow for either fuel delivery to engines or other PMD features. The vanes enable transport of the liquid fuel to tank outlets. The length and shape of the vanes is dependent on the container and can be dependent on the specific use. Center posts may be added in addition to the vanes to direct fluid flow.

Furthermore, control-type PMDs can be used to provide engines with propellant. The control-type PMDs include sponges, troughs, and traps. Sponges are used to normally provide propellant to ignition sources. Propellant transfer in microgravity is a problem that requires specific solutions. PMDs ensure that vapor-free propellant is supplied from a source tank (e.g. a fuel depot) to a receiver tank or engine. Failure to do so for engines will result in combustion inefficiencies and even engine failure. At the present however, most traditional surface tension based PMDs face difficulties when handling cryogenic liquids due to several limitations.

Cryogenic bladders were initially investigated by NASA and several government contractors in the 1960s and 70s. The bladders would encapsulate propellant within spherical bags of polyethylene terephthalate (PET, Mylar®) and polyimide (Kapton®) film, fabricated by epoxying strips of polymer film together. To expel propellant, the bladder would stochastically buckle and crumple. Research into these bladders discontinued after benchtop testing of the PMD found mixing of the liquid hydrogen (LH2) and helium. There were several conjectures as to why this occurred: bulk permeation through the bladder material, tears in the bladder, or improper sealing. Thus, tearing or sealing issues were likely the reason as to the technology not being pursued further and the reduced interest and viability of a cryogenic bladder as a solution to this issue.

Novel solutions that can provide storage and evacuation of cryogenic fluids in various gravitational environments are needed.

### SUMMARY

The present disclosure provides a storage system for cryogenic fluids. In one aspect, the system comprises a housing delimiting a cavity therein and a collapsible container disposed within the cavity and coupled to a surface of the housing, wherein the collapsible container is configured to contain a fluid. An inlet allows for a pressurant to be added to the space between the wall of the housing and the collapsible container. In doing so, the pressure of the space between the housing and the container increases causing the container to assume a collapsed state. An outlet fluidly coupled to the collapsible container is configured to dispense the fluid out of the collapsible container and housing.

In some embodiments, the collapsible container comprises a plurality of panels which are foldable at flexure hinges. In some embodiments, the panels have an average thickness of at least 0.1 μm. In some embodiments, a thickness of the flexure hinges is less than a thickness of the panels. In some embodiments, a radius of curvature of a first portion of the flexure hinges is smaller than a thickness of the panels. In some embodiments, a radius of curvature of a second portion of the flexure hinges is larger than a thickness of the panels.

The plurality of panels may be arranged in at least one of a hexagonal structure and an isogrid structure. In some embodiments, the collapsible container is configured to form a folded pattern when collapsed, wherein the folded pattern includes at least one of a Yoshimaru pattern, a Kresling pattern, a Miura-ori pattern, an accordion pattern, and a hexagonal pattern. In some embodiments, the collapsible container comprises a plurality of channels within the panels of the container configured for flowing a coolant. In some embodiments, the collapsible container is formed from an impermeable material. In some embodiments, the impermeable material is a polyimide, polyethylene terephthalate, or fluropolymer film.

Another aspect of the disclosure provides a storage system in which the collapsible container is not surrounded by a rigid housing. The system may comprise at least one collapsible structure comprising a plurality of panels which are foldable at flexure hinges, wherein the structure is configured to hold a cryogenic fluid therein and is configured to collapse when an external or internal force is applied to the structure, and an outlet fluidly coupled to the collapsible structure, wherein the outlet is configured to dispense the cryogenic fluid out of the collapsible structure. In some embodiments, the system further comprises one or more of a mechanical actuator, a piston, or a pump configured to apply the force to the structure. In some embodiments, the at least one collapsible structure includes a plurality of layered collapsible structures. In some embodiments, the container is configured to distribute a pressurant between an outer layer and an inner layer.

Another aspect of the disclosure provides a method of delivering fluid, comprising loading a cryogenic fluid into a collapsible container in a deployed state, applying a fluid pressure to an exterior of the collapsible container in the deployed state, wherein the fluid pressure provides movement from the deployed state into a collapsed state of the collapsible container, and flowing the cryogenic fluid out of the collapsible container as the container moves from the deployed state to the collapsed state.

Another aspect of the disclosure provides a method of manufacturing a collapsible container as described herein, comprising providing a mold having a predetermined geometry, arranging a polymeric film above the mold, heating the polymeric film, pressing the mold into the polymeric film while applying a vacuum to the polymeric film such that the polymeric film assumes a shape of the mold, and removing the polymeric film from the mold.

The foregoing and other objects, features, and advantages of the present disclosure will become more apparent from the following detailed description, which proceeds with reference to the accompanying figures.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1. A storage system according to some embodiments of the disclosure. The collapsible container encapsulates cryogenic propellant within the tank. The propellant and pressurant remain separated by a nonporous material. As the propellant is expelled from the tank, the collapsible container bellow collapses.

FIG. 2. A storage system according to some embodiments of the disclosure. The system may comprise a collapsible container having two or more collapsible layers.

FIGS. 3A-B. A storage system according to some embodiments of the disclosure. The collapsible container may have a mechanism on the (A) interior or (B) exterior of the container which moves the container into the collapsed state.

FIGS. 4A-B. A folded pattern bellow comprised of 0.002″ thick Kapton® film in (A) extended and (B) collapsed positions.

FIG. 5. The thermal and mass transfer at the liquid-vapor interface within a propellant tank. QIL and QUI mark the heat transfer from the interface to the liquid, and the ullage to the interface, respectively. Evaporation is indicated by \dot{m}ᵥ. TU and TL represent the ullage and liquid temperatures.

FIG. 6. A three-corner fold, inscribed by a circle, that can be found when collapsing a cryogenic collapsible container. Folded pattern bellow comprised of electrical tape and 0.003″ thick PET film.

FIGS. 7A-B. (A) Schematic of cryogenic permeation test cell. It is inserted into a high vacuum chamber and cooled with a cryocooler. (B) Gelbo-flex tester.

FIGS. 8A-B. (A) An extended folded pattern structure based off the Yoshimura fold pattern. It was constructed from 0.003″ thick PET. (B) The Yoshimura fold structure compressed with a ruler. It is the deformation of the hinges that allows the folded pattern to actuate.

FIG. 9. Schematic of an unfolded Yoshimura pattern. The diagonal and dashed horizontal lines are folds/hinges, while triangles serve as the panels of the folded pattern bellows.

FIGS. 10A-B. Schematics of in the wall geometry of the folded pattern structure. t1 is the maximum thickness of a panel, t2 is the thickness of a hinge, and that t2<t1. (A) Panels are thicker than hinges to ensure the former is stiffer than the latter. (B) Isogrid structure is incorporated into the panel to increase stiffness, while still possessing less mass than the panel in (A).

FIGS. 11A-B. (A) Hinge with an outer radius of curvature, rA, that is <t1. (B) Hinge with an outer radius of curvature, rB, that is >t1. That rB>rA ensures that the hinge in B. experiences less stress than in A. during actuation.

FIG. 12. A representative isogrid structure.

FIGS. 13A-D. Exemplary (A) Kresling pattern, (B) Miura-ori pattern, (c) accordion pattern, and (D) hexagonal pattern according to some embodiments of the disclosure.

FIG. 14. Vapor cooling channels incorporated into the wall geometry of the container, the folded pattern structure can serve as an expulsion device to store liquid propellant in a rocket tank. As an example of this application, the folded pattern structure could store liquid hydrogen (LH2), while running gaseous helium (GHe) coolant through the vapor channels to intercept any heat leak into the propellant.

FIGS. 15A-B. (A) Mold of origami bladder and (B) Vacuum-formed bladder fabricated from polycarbonate.

### DETAILED DESCRIPTION

The following are definitions of terms that may be used in the present specification. The initial definition provided for a group or term herein applies to that group or term throughout the present specification individually or as part of another group, unless otherwise indicated.

Additionally, it will be understood that any list of such candidates or alternatives is merely illustrative, not limiting, unless implicitly or explicitly understood or stated otherwise.

As used in this specification and the appended claims, the singular forms “a”, “an” and “the” include plural referents unless the content clearly dictates otherwise. The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

In addition, unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Described herein are collapsible container based systems that are an attractive alternative to surface-tension PMDs for handling cryogenic liquids. The collapsible containers comparatively may 1) allow higher expulsion flow rates than vanes and sponges, 2) significantly reduce operational complexity, and 3) thermally insulate the propellant from environmental heat leaks.

Furthermore, while historical cryogenic containers suffered from the low ductility of polymer films at cryogenic temperatures, the present disclosure shows that the incorporation of folded patterns (a compliant mechanism) into the collapsible container increases the reusability of the cryogenic PMD.

The cryogenic propellant systems possess unique challenges that make expulsion collapsible containers more desirable for certain applications. Cryogens have lower surface tensions than room-storable propellants: at 20.4 K, hydrogen possesses a surface tension 34 times smaller than that of hydrazine at 303 K. This low tension further decreases the already limited flow rates vanes and sponges can sustain for liquid exiting a tank. It is difficult for PMDs to handle flow rates required for cryogenic fuel systems. As expulsion collapsible containers do not rely upon surface tension (a collapsible container instead mechanically pumps the liquid when subjected to a pressure gradient), the disclosed systems and methods have the advantage of functioning at high flow rates.

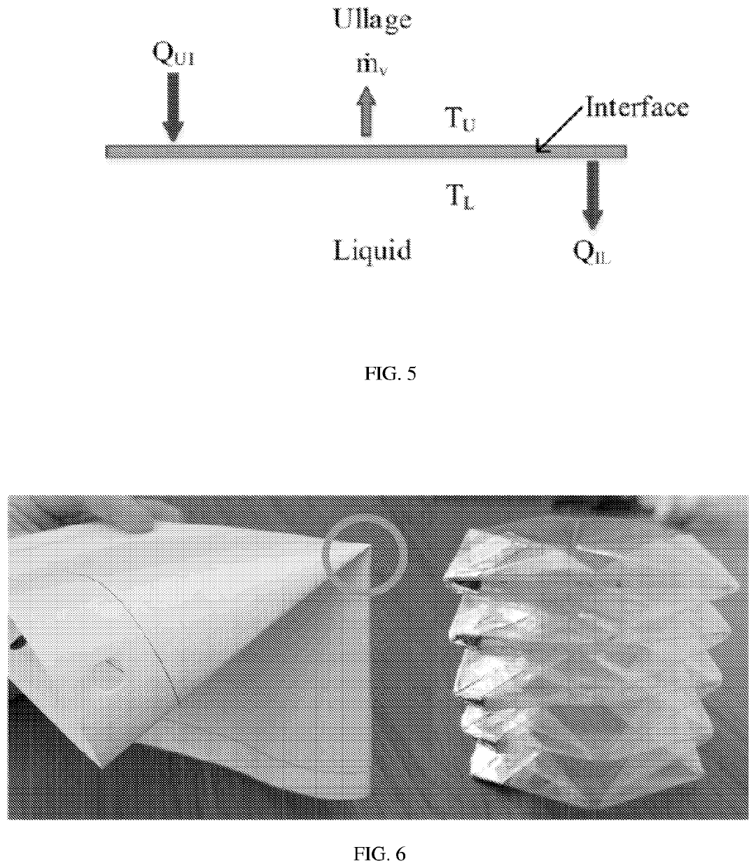

Gallery arms have been used previously to meet high flow rate demands of future cryogenic propulsion systems. These PMDs primarily use porous screens to maintain phase separation within the tank, the behavior of which is governed by the bubble-point pressure. This parameter determines the maximum sustainable expulsion flow rate. However, gallery arms are complex systems, resulting in lower reliability. Complications arise when expelling propellant from the tank because of thermal and mass transfer, e.g. evaporation/condensation, at the pressurant-propellant interface as seen in FIG. 5. Pressure introduced into the tank will likely be hotter than the cryogen, encouraging evaporation. This can dry out the screens and significantly degrade the screen bubble-point pressure. If the temperature differential between helium pressurant and LH2 is 100 K, then the bubble-point pressure can decrease by 20-80%, depending on screen coarseness.

A collapsible container as described herein simplifies the expulsion process. By arranging a non-porous membrane between the propellant and gas, mass transfer between the two phases is inhibited by the impermeability of the membrane.

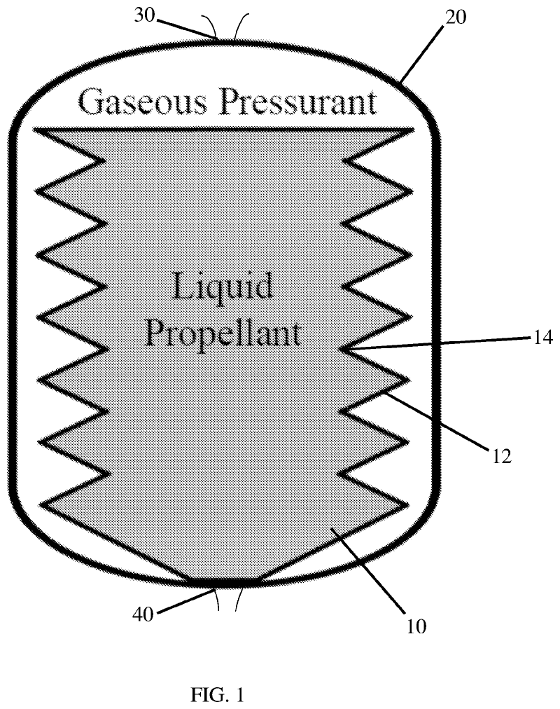

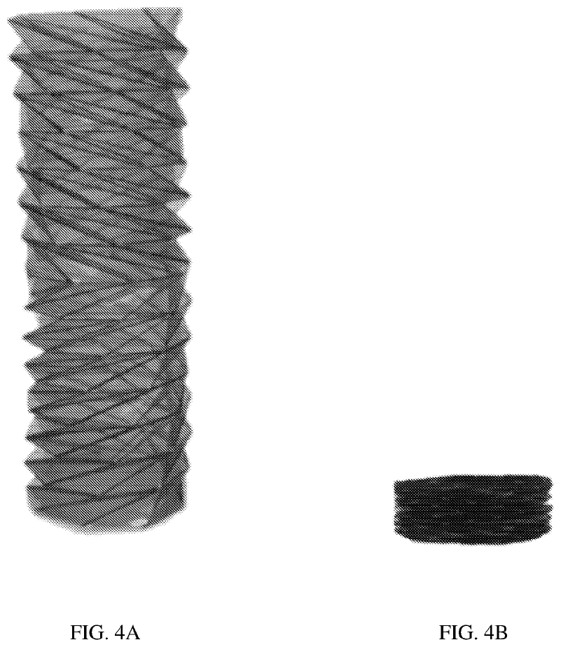

With reference to FIG. 1, a system as described herein may comprise a collapsible container 10 disposed within the cavity of a housing 20. The housing 20 is generally formed from a rigid, non-collapsible material. For example, the housing 20 may be a steel or aluminum tank. An inlet 30 allows for a pressurant to be added to the cavity space between the inner surface of the housing 20 and the exterior surface of the collapsible container 10. In doing so, the pressure of the space between the housing and the container increases causing the container to assume a collapsed state. An outlet 40 fluidly coupled to the collapsible container is configured to dispense a fluid out of the collapsible container and housing. A deployed state of the container is shown in FIG. 4A and a collapsed state is shown in FIG. 4B.

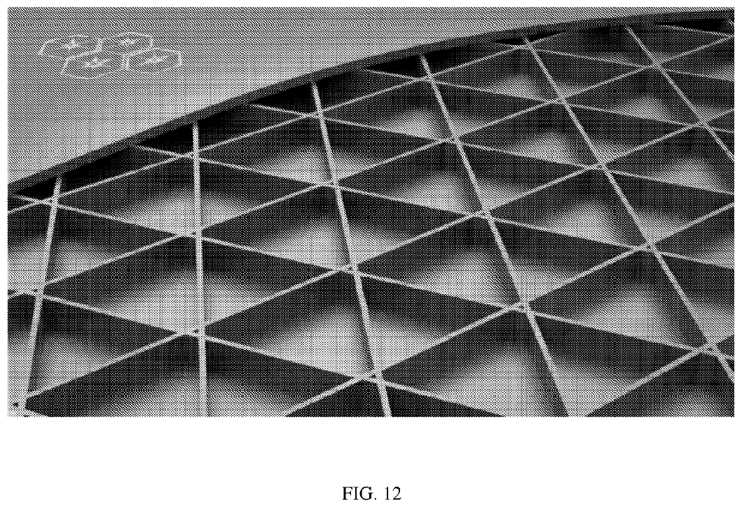

The collapsible container 10 may be formed from a plurality of panels 12 which are foldable at flexure hinges 14. A flexure hinge is a flexible region between two adjacent rigid panels that undergo relative limited rotation in a mechanism (FIG. 6). In some embodiments, the panels have an average thickness of at least 10⁻¹-10^{4.5} μm. With reference to FIGS. 10A-B, a thickness of the flexure hinges may be is less than a thickness of the panels. In some embodiments, a thickness of the flexure hinge is about the same as the thickness of the panels. In some embodiments, the flexure hinge has a thickness of 10⁻²-10^{4.5} μm. With reference to FIGS. 11A-B, a radius of curvature of a first portion of the flexure hinges may be smaller than a thickness of the panels and a radius of curvature of a second portion of the flexure hinges may be larger than a thickness of the panels. In some embodiments, the radius of curvature has a thickness of 10⁻¹-10^{5.5} μm.

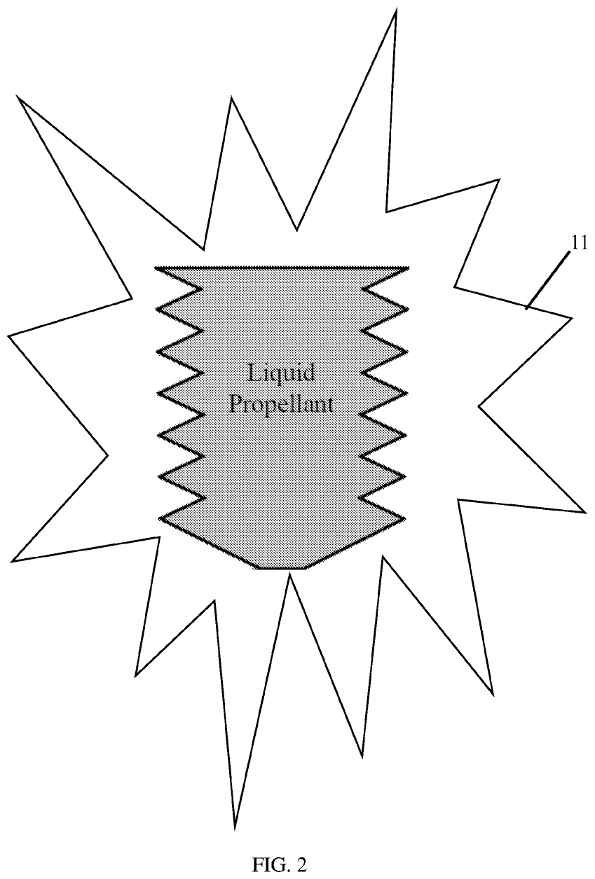

With reference to FIG. 2, the storage system may comprise nested collapsible containers with or without any exterior rigid housing. The container may comprise one or more additional collapsible layers 11 that have the same or a different fold pattern/geometry as compared to the interior most container that holds and dispenses the fluid. In some embodiments, the container comprises 2-100 collapsible layers, e.g. 30-60 layers. In some embodiments, the container is configured to distribute a pressurant between an outer layer and an inner layer of the container.

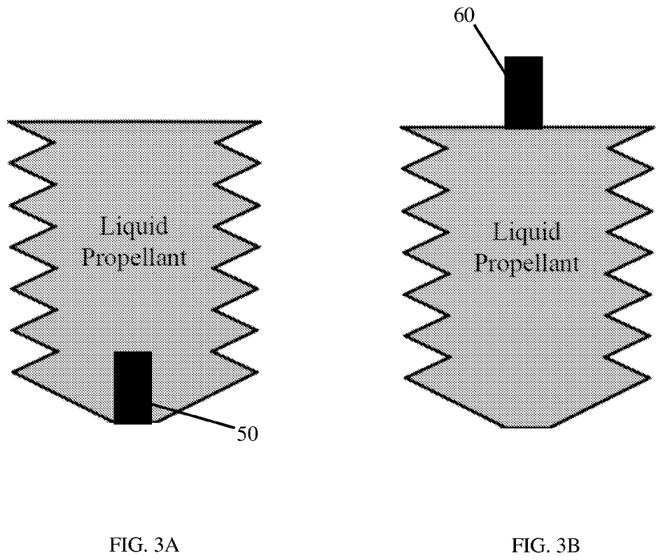

With reference to FIGS. 3A-B, a storage system as described herein, whether containing one or a plurality of collapsible layers, may further comprise an internal actuator 50 or external actuator 60 that applies the force needed to collapse the container. An actuator as described herein may comprise a mechanical actuator that physically moves the collapsible container between the deployed and collapsed states. In some embodiments, the actuator is a piston or a pump configured to apply an external or internal fluid pressure to the collapsible container, for example, a pump may decrease the pressure within the internal space of the container causing the container to collapse.

In some embodiments, the collapsible container is formed from a material selected from a polyimide (e.g. Kapton®), polyethylene terephthalate (PET, Mylar®), polyetheretherketone (PEEK), polytetrafluoroethylene (Teflon®), fluorinated ethylene propylene (FEP), and perfluoroalkoxy (PFA). Extrapolation with the Arrhenius equation (from an empirical data set between 300-150 K) suggests that the permeability of Kapton® films to helium gas at 20 K is 36 orders or magnitude lower than it is at 300 K. Thus, using Kapton® and other polymers for the collapsible container material allows for an effective elimination of the mass transfer at cryogenic temperatures.

Impermeable materials also prevent pressurant from dissolving into the propellant in significant quantities during long-duration missions. The pressurant solute could adversely affect engine performance (e.g. induce cavitation at the turbo-pumps for a pump-fed system). Assuming no mixing within the tank, this is not an issue for mission lengths of several hours, where the equilibrium solubility of pressurant molecules/atoms in the liquid is not approached in that time period. As an example, the slow diffusion of helium into liquid methane requires 6 hours for the helium concentration wave to appreciably traverse 1 cm from the liquid-vapor interface. Behavior for helium diffusion in liquid hydrogen (LH2), or nitrogen diffusion in liquid oxygen (LOX), are potentially similar. However, over greater time periods, these equilibrium solubilities become relevant. And if higher pressure tanks are implemented during long duration missions, equilibrium solubilities could be higher, exacerbating any resulting issues.

As used herein, “impermeable” refers to the production of a gas transmission rate of of ≤1*10⁻⁸ mol/s/m².

The collapsible container is sized to hold a volume of liquid, e.g. cryogenic fuel, of about 10⁻⁸-10⁷ liters.

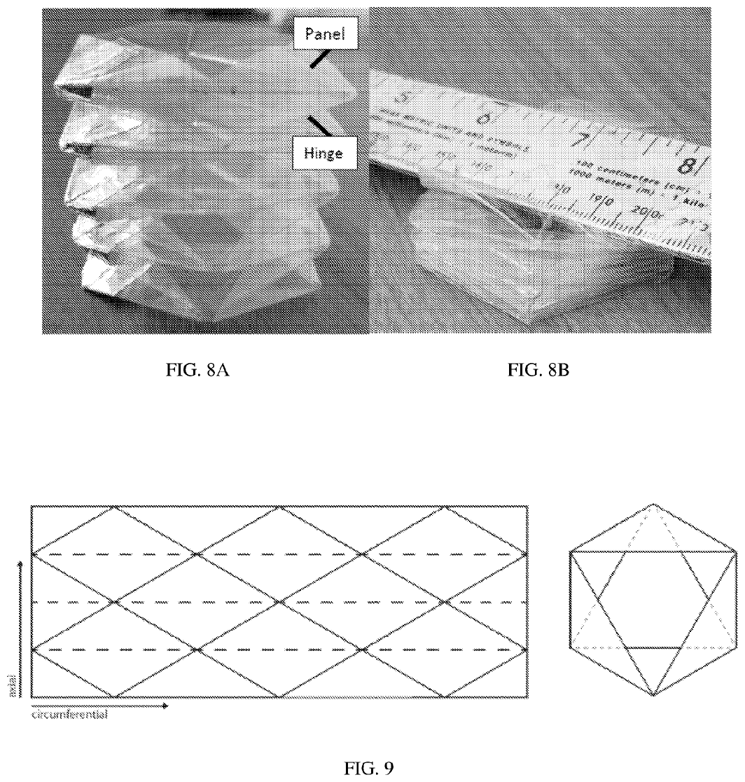

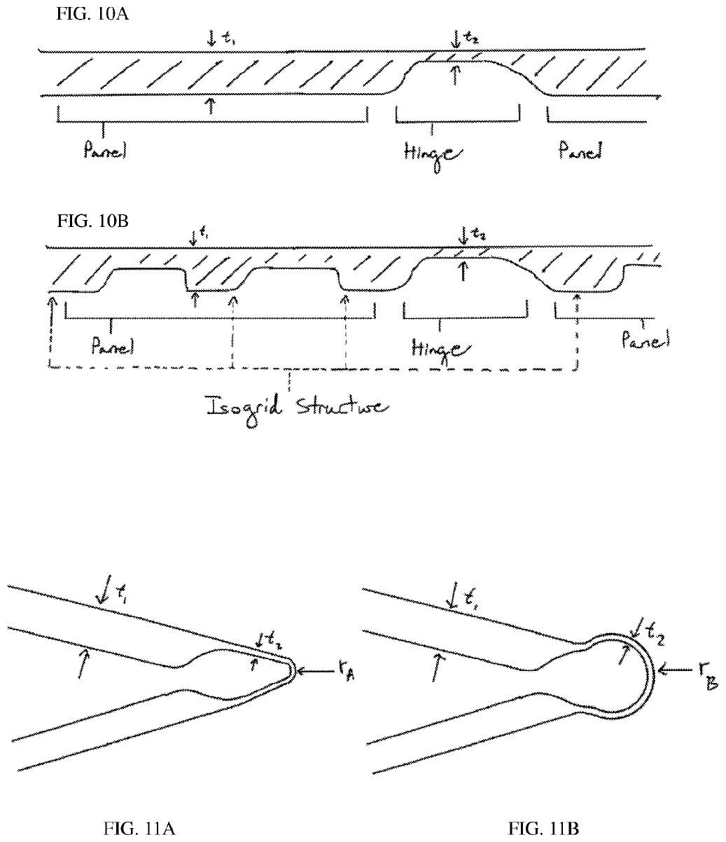

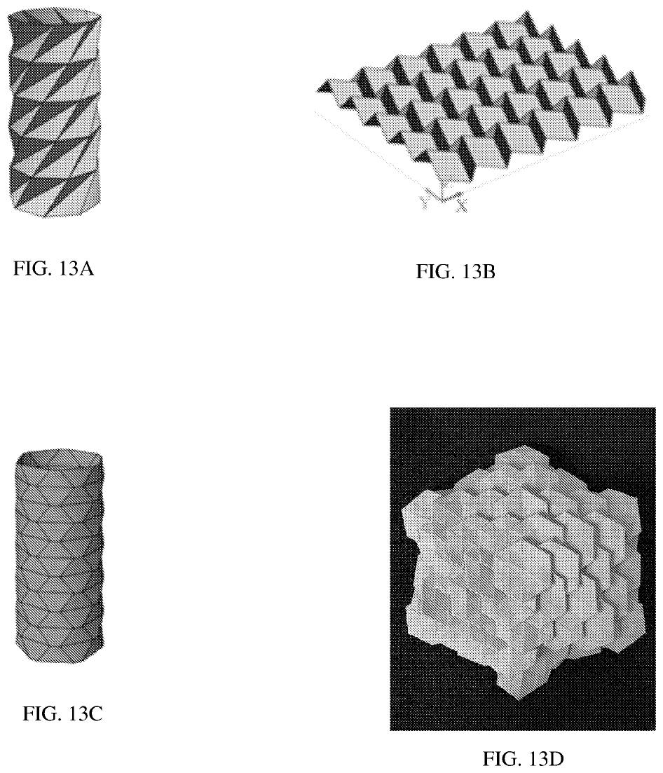

With reference to FIGS. 10 and 12, the plurality of panels may possess at least one of a hexagonal structure and an isogrid structure. These structures may be etched into the panels to provide rigidity. The structures are geometric characteristics of the panels. In some embodiments, the collapsible container is configured to form a predictable folded pattern, e.g. an origami pattern, when collapsed. In some embodiments, the folded pattern includes at least one of a Yoshimaru pattern (FIGS. 8-9), a Kresling pattern (FIG. 13A), a Miura-ori pattern (FIG. 13B), an accordion pattern (FIG. 13C), and a hexagonal pattern (FIG. 13D).

The Yoshimaru pattern is a triangular mesh buckling pattern which produces a corrugated shape resembling the Schwarz lantern. The Kresling pattern is a cylindrical origami pattern comprising identical triangular panels with cyclic symmetry, functioning under the spontaneous buckling of a thin cylindrical shell under torsional loading. The crease patterns of the Miura-ori pattern form a tessellation of the surface by parallelograms. In one direction, the creases lie along straight lines, with each parallelogram forming the mirror reflection of its neighbor across each crease. In the other direction, the creases zigzag, and each parallelogram is the translation of its neighbor across the crease. Each of the zigzag paths of creases consists solely of mountain folds or of valley folds, with mountains alternating with valleys from one zigzag path to the next. Each of the straight paths of creases alternates between mountain and valley folds. The flat pattern may be curved along the x-axis to provide for a collapsible container as described herein. The accordion fold utilizes a series of valley, mountain, and inside reverse folds.

In the operation of the storage system described herein, a cryogenic liquid is loaded into the collapsible container in a deployed state, e.g. via the outlet 40. A fluid pressure is then applied to an exterior of the collapsible container, wherein the fluid pressure (i.e. pressurant) provides movement from the deployed state into a collapsed state of the collapsible container. The movement of the container into the collapsed state causes the cryogenic fluid to flow out of the collapsible container via outlet 40.

As used herein, a “pressurant” is a fluid (liquid or gas) that when dispered into the cavity provides an external pressure on the collapsible structure causing the container to assume a collapsed state. Exemplary pressurants include, but are not limited to, helium, nitrogen, hydrogen, oxygen, and methane. In some embodiments, the pressurant provides a pressure of at least 1-300 kPa.

The interior of the collapsible structure is configured to contain fuel which may comprise a propellant, such as a gas or liquid propellant which may be compressed. A propellant is a mass that is expelled or expanded in such a way as to create a thrust or other motive force. In some embodiments, the byproducts of substances used as fuel may be used as a reaction mass (propellant).

In electrically powered spacecraft, electricity is used to accelerate the propellant. An electrostatic force may be used to expel positive ions, or the Lorentz force may be used to expel negative ions and electrons as the propellant. Electothermal engines use the electromagnetic force to heat low molecular weight gases (e.g. hydrogen, helium, ammonia) into a plasma and expel the plasma as propellant. In the case of a resistojet rocket engine, the compressed propellant is simply heated using resistive heating as it is expelled to create more thrust.

In chemical rockets and aircraft, fuels are used to produce an energetic gas that can be directed through a nozzle, thereby producing thrust. In rockets, the burning of rocket fuel produces an exhaust, and the exhausted material is usually expelled as a propellant under pressure through a nozzle. The exhaust material may be a gas, liquid, plasma, or a solid. In powered aircraft without propellers such as jets, the propellant is usually the product of the burning of fuel with atmospheric oxygen so that the resulting propellant product has more mass than the fuel carried on the vehicle.

In chemical rockets, chemical reactions are used to produce energy which creates movement of a fluid which is used to expel the products of that chemical reaction (and sometimes other substances) as propellants. For example, in a simple hydrogen/oxygen engine, hydrogen is burned (oxidized) to create H₂O and the energy from the chemical reaction is used to expel the water (steam) to provide thrust. Often in chemical rocket engines, a higher molecular mass substance is included in the fuel to provide more reaction mass.

Rocket propellant may be expelled through an expansion nozzle as a cold gas, that is, without energetic mixing and combustion, to provide small changes in velocity to spacecraft by the use of cold gas thrusters, usually as maneuvering thrusters.

Exemplary propellants include, but are not limited to, cryogenic oxygen, hydrogen, hydrocarbon, ethanol, methane, hydrogen peroxide, kerosene, red fuming nitric acid, unsymmetrical dimethylhydrazine, dinitrogen tetroxide, hydrazine, and mixtures thereof.

In long-term missions, it is desirable to limit heat flux into the cryogenic propellant. Traditionally, liquid is in direct contact with the walls, so stray heat leak into the tank directly evaporates and/or boils the liquid cryogen. Active thermal control systems can remove this heat leak at the cost of increased system mass. This trade-off is exacerbated by surface tension PMDs in contact with the tank wall, such as vanes. These PMDs may act like fins and conduct heat into the bulk liquid. Collapsible containers instead insulate the propellant and reduce heat flux. FIG. 1 shows there is a gas layer between the collapsible container and tank walls. In addition to isolating the liquid propellant from potential hot spots on the tank wall, the gas forms an in-series thermal resistance network with insulation on the tank exterior, typically spray-on foam insulation (SOFI). The thermal conductivities for helium pressurant in a LH2 tank, and nitrogen pressurant in a LOX tank are depicted in Table 1. At lower temperatures, these conductivities are within a half order of magnitude of the apparent thermal conductivity of SOFI, ˜0.008 Wm-1K-1, at high vacuum. If the gas layer thickness is greater than the typical thickness of SOFI on a tank, ˜1 inch, then the gas may provide a comparable thermal resistance to SOFI in microgravity. Heat flux through the tank and into the propellant is then significantly reduced. This scenario is particularly useful for upper-stages, where parts of the tank exterior comprise the outer mold line of a rocket and multi-layer insulation cannot be installed.

TABLE 1
Thermal conductivities of pressurant gases over a range of
temperatures at a representative tank pressure.

| | Thermal | Temperature | |
|---|---|---|---|
| | conductivity Range | Range | Pressure |
| Pressurant | (Wm⁻¹K⁻¹) | (K) | (kPa) |
| Nitrogen | 0.0088-0.018 | 90-200 | 200 |
| Helium | 0.026-0.12 | 20-200 | 200 |

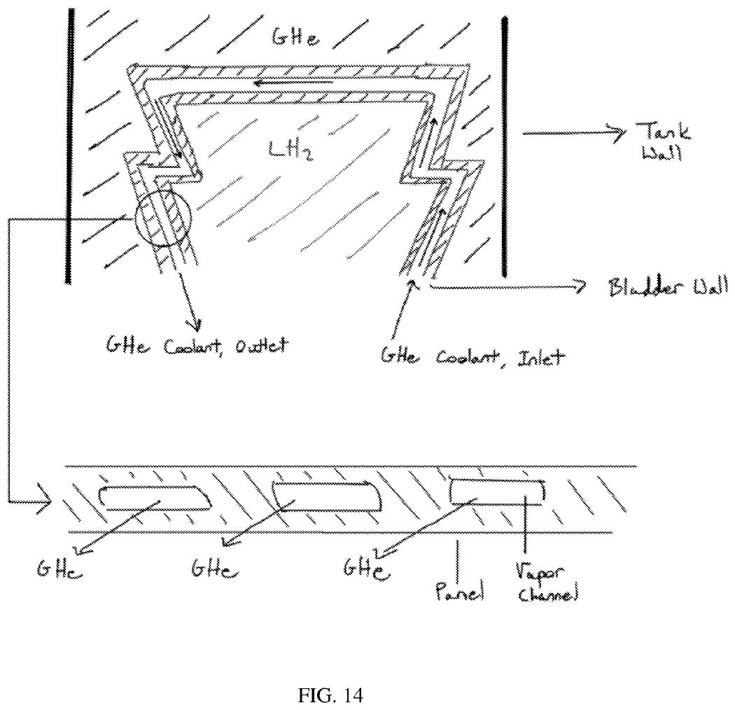

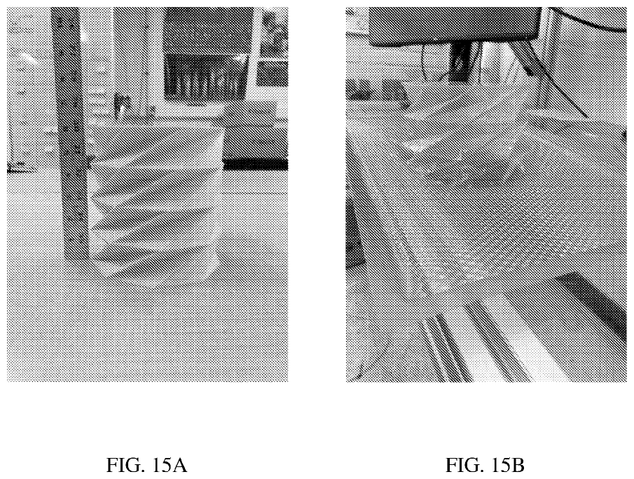

With reference to FIG. 14, the collapsible container may comprise a plurality of channels within the panels of the container configured for flowing a coolant. Exemplary coolants include but are not limited to, helium, hydrogen, and nitrogen.

The combination of high expulsion flow rates, a barrier against mass transfer, and inherent thermal insulation make the cryogenic collapsible container a simple and high performing alternative to existing cryogenic PMDs. This is particularly true for long-duration missions seen by fuel depots and in-space rocket engines traveling to the Moon or Mars, which require the use of mass and cost expensive thermal control systems to prevent/reduce propellant boil off.

Further embodiments of the disclosure include methods for making a storage system as described herein. To manufacture a collapsible container, several key metrics must be met. First, the structure must be liquid tight to prevent fuel from leaking. Second, the process must repeatably produce high quality storage systems with consistency between the collapsible containers/bladders. Finally, the manufacturing process should allow for a wide range of volumes to meet demands of various applications. A vacuum forming manufacturing method fulfills these three criteria.

In some embodiments, to vacuum form a collapsible container, a mold is 3D printed or machined into the desired geometry (FIG. 15A). Next, the mold is then placed into a vacuum forming machine and a polymeric film is positioned above. The film is then heated until it is close to its melt temperature, once at temperature, a vacuum is turned on and the mold is pressed into the film (FIG. 15B). The vacuum pulls the near liquid polymer film into the mold, and as it cools the polymer hardens and retains the shape of the mold. Finally, the mold is released from the part.

During the vacuum forming process, many different polymeric materials can be used, including fluoropolymers, such as Fluorinated ethylene propylene (FEP) and Perfluoroalkoxy (PFA) and other polymers such as polyimide (e.g. Kapton®), polyethylene terephthalate (PET, Mylar®), polyetheretherketone (PEEK), and polytetrafluoroethylene (Teflon®). Bladders that are vacuum-formed from these materials can be used for storage of fluids such as liquid hydrogen, liquid oxygen, and other propellants/fluids as described herein. These materials have been demonstrated to survive 1000s of cycles within the cryogenic regime, at least when fabricated via hand-folding.

It should be emphasized that the above-described embodiments and following specific examples of the present invention, particularly, any “preferred” embodiments, are merely possible examples of implementations, merely set forth for a clear understanding of the principles of the invention. Many variations and modifications may be made to the above described embodiment(s) of the invention without departing substantially from the spirit and principles of the invention. All such modifications and variations are intended to be included herein within the scope of this disclosure and the present invention and protected by the following claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### EXAMPLE

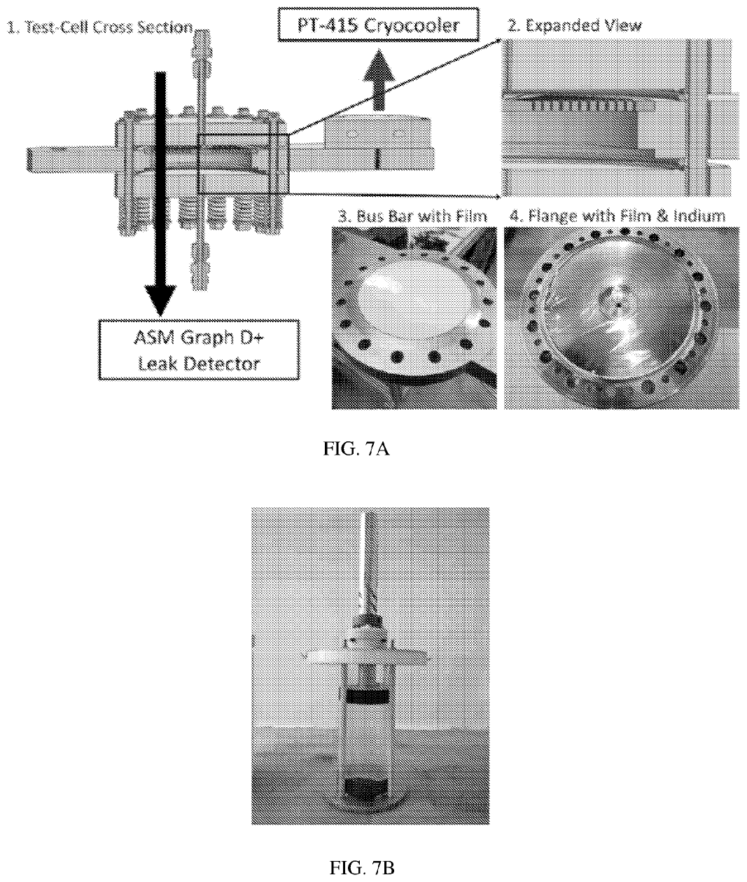

The hydrogen permeability of polymer films between 20-200 K can be determined using a permeation test cell as shown in FIG. 7A.

A fatigue test of the collapsible container may be performed using a Gelbo-flex tester as shown in FIG. 7B. For example, the container may be linearly actuated 100 or more times at 77K. Tears can be identified visually or by subjecting the material to a permeation test to check for enhanced permeation rates.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A storage system for a cryogenic fluid, comprising:
a housing delimiting a cavity therein;
a collapsible container disposed within the cavity and coupled to a surface of the housing, wherein the collapsible container is configured to contain a fluid;
an inlet configured to distribute a pressurant within the cavity and about the collapsible container, and
an outlet fluidly coupled to the collapsible container, wherein the outlet is configured to dispense the fluid out of the collapsible container and housing.

2. The storage system of claim 1, wherein the collapsible container comprises a plurality of panels which are foldable at flexure hinges.

3. The storage system of claim 2, wherein the panels have an average thickness of at least 0.1 μm.

4. The storage system of claim 2, wherein a thickness of the flexure hinges is less than a thickness of the panels.

5. The storage system of claim 2, wherein a radius of curvature of a first portion of the flexure hinges is smaller than a thickness of the panels and wherein a radius of curvature of a second portion of the flexure hinges is larger than a thickness of the panels.

6. The storage system of claim 2, wherein the plurality of panels are arranged in at least one of a hexagonal structure and an isogrid structure.

7. The storage system of claim 1, wherein the collapsible container is configured to form a folded pattern when collapsed, wherein the folded pattern includes at least one of a Yoshimaru pattern, a Kresling pattern, a Miura-ori pattern, an accordion pattern, and a hexagonal pattern.

8. The storage system of claim 2, wherein the collapsible container comprises a plurality of channels within the panels of the container configured for flowing a coolant.

9. The storage system of claim 1, wherein the collapsible container is formed from an impermeable material.

10. The storage system of claim 9, wherein the impermeable material is a polyimide, polyethylene terephthalate, or fluropolymer film.

11. A collapsible container, comprising:
at least one collapsible structure comprising a plurality of panels which are foldable at flexure hinges, wherein the structure is configured to hold a cryogenic fluid therein and is configured to collapse when an external or internal force is applied to the structure; and
an outlet fluidly coupled to the collapsible structure, wherein the outlet is configured to dispense the cryogenic fluid out of the collapsible structure.

12. The collapsible container of claim 11, further comprising one or more of a mechanical actuator, a piston, or a pump configured to apply the force to the collapsible structure.

13. The collapsible container of claim 11, wherein the at least one collapsible structure includes a plurality of layered collapsible structures.

14. The collapsible container of claim 13, wherein the container is configured to distribute a pressurant between an outer layer and an inner layer of the collapsible structures.

15. A method of delivering fluid, comprising:
loading a cryogenic fluid into a collapsible container in a deployed state;
applying a fluid pressure to an exterior of the collapsible container in the deployed state, wherein the fluid pressure provides movement from the deployed state into a collapsed state of the collapsible container, and
flowing the cryogenic fluid out of the collapsible container as the container moves from the deployed state to the collapsed state.

16. The method of claim 15, wherein the collapsible container comprises a plurality of panels which are foldable at flexure hinges.

17. The method of claim 16, wherein the panels have an average thickness of at least 0.1 μm.

18. The method of claim 16, wherein a thickness of the flexure hinges is less than a thickness of the panels.

19. The method of claim 16, wherein a radius of curvature of a first portion of the flexure hinges is smaller than a thickness of the panels and wherein a radius of curvature of a second portion of the flexure hinges is larger than a thickness of the panels.

20. The method of claim 16, wherein the plurality of panels are arranged in at least one of a hexagonal structure and an isogrid structure when in the deployed state.

21. The method of claim 15, wherein the collapsible container forms a folded pattern when in the collapsed state, wherein the folded pattern includes at least one of a Yoshimaru pattern, a Kresling pattern, a Miura-ori pattern, an accordion pattern, and a hexagonal pattern.

22. The method of claim 16, further comprising flowing a coolant through a plurality of channels arranged within the panels of the container.

23. The method of claim 15, wherein the collapsible container is formed from an impermeable material.

24. The method of claim 23, wherein the impermeable material is a polyimide, polyethylene terephthalate, or fluropolymer film.

25. A method of manufacturing a collapsible container according to claim 11, comprising:
providing a mold having a predetermined geometry;
arranging a polymeric film above the mold;
heating the polymeric film;
pressing the mold into the polymeric film while applying a vacuum to the polymeric film such that the polymeric film assumes a shape of the mold; and
removing the polymeric film from the mold.

26. The method of claim 25, wherein the predetermined geometry is at least one of a hexagonal structure and an isogrid structure.

27. The method of claim 25, wherein the predetermined geometry is configured to form a folded pattern when collapsed, wherein the folded pattern includes at least one of a Yoshimaru pattern, a Kresling pattern, a Miura-ori pattern, an accordion pattern, and a hexagonal pattern

28. The method of claim 25, wherein the polymeric film is a polyimide, polyethylene terephthalate, or fluropolymer film.
